(19) United States
(12) Patent Application Publication
(10) Pub. No.: US 2018/0203813 A1
(43) Pub. Date: Jul. 19, 2018

(54) METHODS FOR PROCESSING RETURN ENTITIES ASSOCIATED WITH MULTIPLE REQUESTS IN SINGLE INTERRUPT SERVICE ROUTINE THREAD AND APPARATUSES USING THE SAME

(71) Applicant: Shannon Systems Ltd., Shanghai (CN)

(72) Inventor: Xueshi YANG, Cupertino, CA (US)

(21) Appl. No.: 15/743,464

(22) PCT Filed: Sep. 29, 2015
(86) PCT No.: PCT/CN2015/091120

§ 371 Date: Jan. 10, 2018

(51) Int. Cl. G06F 13/24; G06F 9/48; G06F 9/54; G06F 3/06

(52) U.S. Cl. CPC G06F 13/24; G06F 9/4806; G06F 2209/548; G06F 3/0659; G06F 9/54

(57) ABSTRACT

A method for processing return entities associated with multiple requests in a single ISR (Interrupt Service Routine) thread, performed by one core of a processing unit of a host device, is introduced. Entities are removed from a queue, which are associated with commands issued to a storage device, and the removed entities are processed until a condition is satisfied.

### BACKGROUND

### Technical Field

The present invention relates to flash memory, and in particular to methods for processing return entities associated with multiple requests in a single ISR (Interrupt Service Routine) thread and apparatuses using the same.

### Description of the Related Art

Flash memory devices typically include NOR flash devices and NAND flash devices. NOR flash devices are random access—a host accessing a NOR flash device can provide the device any address on its address pins and immediately retrieve data stored in that address on the device's data pins. NAND flash devices, on the other hand, are not random access but serial access. It is not possible for NOR to access any random address in the way that is described above. Instead, the host has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. After a return entity associated with an issued command, such as data, a processing status, an error message etc, has been replied, a host connecting to the flash memory device processes one return entity in a single ISR (Interrupt Service Handler) thread. Typically, the ISR thread ends and returns control to the interrupted thread once completing the process of the return entity. However, in a multi-core processing unit, the end of the ISR thread will trigger a context switch between cores, leading to a certain level of overhead. Accordingly, what is needed are methods for processing return entities associated with multiple requests in a single ISR thread and apparatuses using the same.

### BRIEF SUMMARY

An embodiment of a method for processing return entities associated with multiple requests in a single ISR (Interrupt Service Routine) thread, performed by one core of a processing unit of a host device, is introduced. Entities are removed from a queue, which are associated with commands issued to a storage device, and the removed entities are processed until a condition is satisfied.

An embodiment of an apparatus for processing return entities associated with multiple requests in a single ISR thread is introduced. The apparatus at least contains a queue and a processing unit. The processing unit contains multiple cores and is coupled to the queue. One core of the processing unit loads and executes the ISR thread to remove entities from the queue, which are associated with commands issued to a storage device, and processes the removed entities until a condition is satisfied.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is the system architecture of a flash memory according to an embodiment of the invention;

FIG. 2 shows a schematic diagram depicting a storage unit of a flash memory according to an embodiment of the invention;

FIG. 3 is the system architecture of a host device according to an embodiment of the invention;

FIG. 4 is a flowchart illustrating a method for interacting with a storage device performed by an interface controller according to an embodiment of the invention;

FIGS. 5 and 6 are flowcharts illustrating methods for dealing with entities kept in a queue performed by a single ISR thread according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

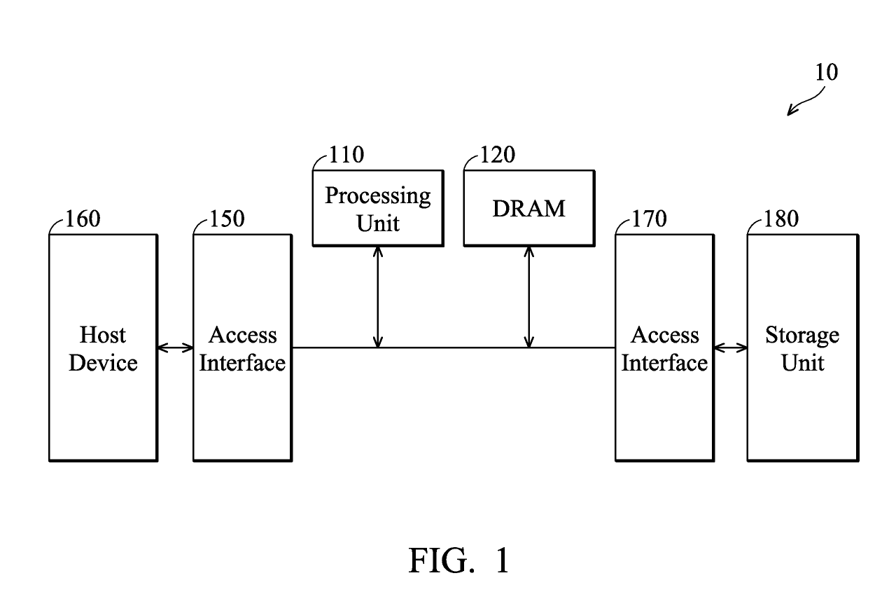

FIG. 1 is the system architecture of a flash memory according to an embodiment of the invention. The system architecture 10 of the flash memory contains a processing unit 110 that is configured to write data into a designated address of a storage unit 180, and read data from a designated address thereof. Specifically, the processing unit 110 writes data into a designated address of the storage unit 10 through an access interface 170 and reads data from a designated address through the same interface 170. The system architecture 10 uses several electrical signals for coordinating commands and data transfer between the processing unit 110 and the storage unit 180, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc. The access interface 170 may communicate with the storage unit 180 using a SDR (Single Data Rate) protocol or a DDR (Double Data Rate) protocol, such as ONFI (open NAND flash interface), DDR toggle, etc. The processing unit 110 may communicate with other electronic devices through an access interface 150 using a standard protocol, such as USB (Universal Serial Bus), ATA (Advanced Technology Attachment), SATA (Serial ATA), PCI-E (Peripheral Component Interconnect Express) etc. A host device 160 may provide an LBA (Logical Block Address) to the processing unit 110 through the access interface 150 to indicate a particular region for data to be read from or written into. However, in order to optimize the data write efficiency, the access interface 170 distributes data with continuous LBAs across different physical regions of the storage unit 180. Thus, a storage mapping table, also referred to as an H2F (Host-to-Flash) table, is stored in a DRAM (Dynamic Random Access Memory) 120 to indicate which location in the storage unit 180 data of each LBA is physically stored in. The processing unit 110, the DRAM 120, the register 130, the access interfaces 150 and 170, and the storage unit 180 may be referred to collectively as a storage device.

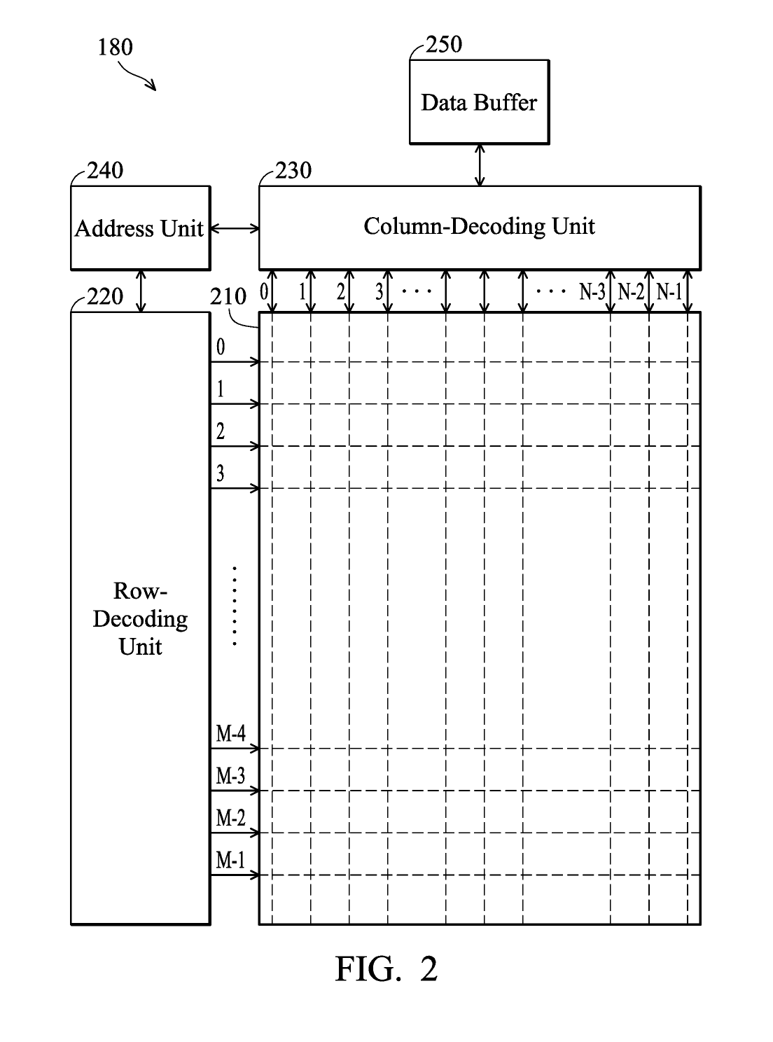

FIG. 2 shows a schematic diagram depicting a storage unit of a flash memory according to an embodiment of the invention. A storage unit 180 includes an array 210 composed of MxN memory cells, and each memory cell may store at least one bit of information. The flash memory may be a NAND or NOR flash memory, etc. In order to appropriately access the desired information, a row-decoding unit 220 is used to select appropriate row lines for access. Similarly, a column-decoding unit 230 is employed to select an appropriate number of bytes within the row for output. An address unit 240 applies row information to the row-decoding unit 220 defining which of the N rows of the memory cell array 210 is to be selected for reading or writing. Similarly, the column-decoding unit 230 receives address information defining which one or ones of the M columns of the memory cell array 210 are to be selected. Rows may be referred to as wordlines by those skilled in the art, and columns may be referred to as bitlines. Data read from or to be applied to the memory cell array 210 is stored in a data buffer 250. Memory cells may be SLCs (Single-Level Cells), MLCs (Multi-Level Cells) or TLCs (Triple-Level Cells).

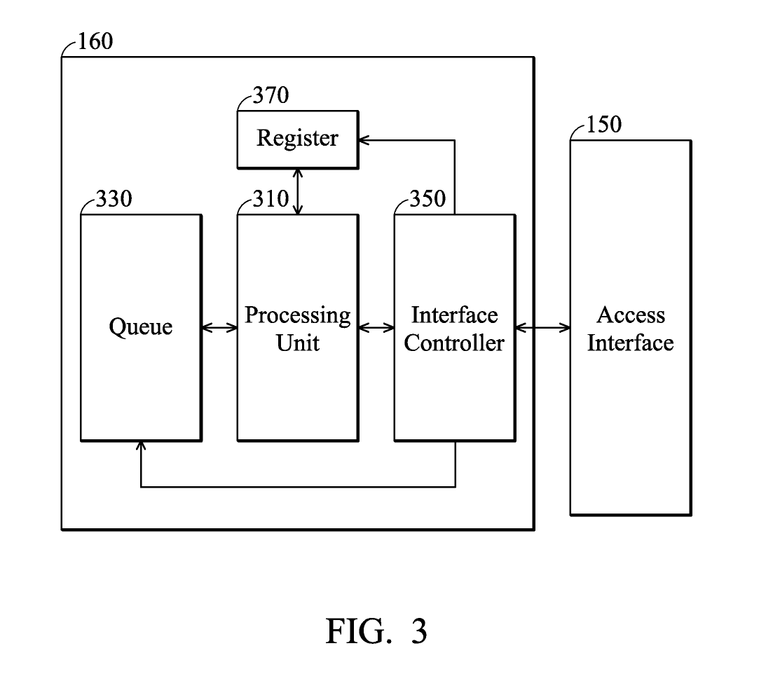

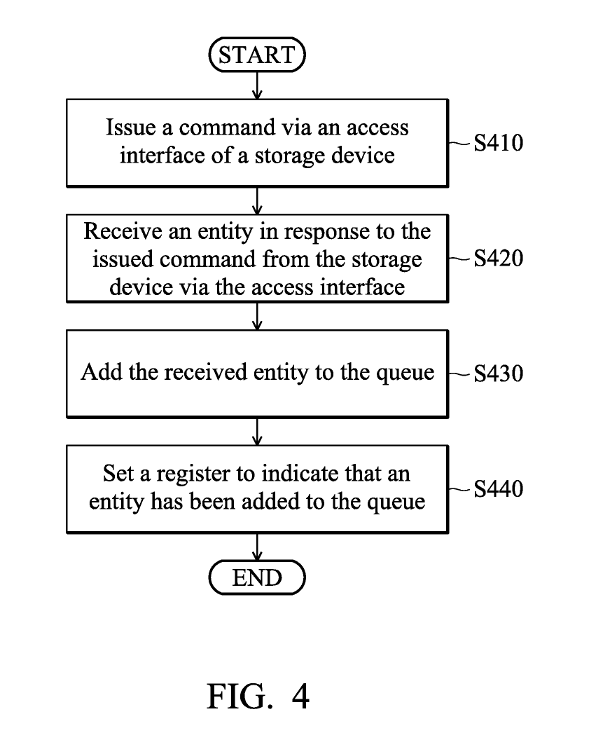

FIG. 3 is the system architecture of a host device according to an embodiment of the invention. The system architecture may be practiced in a desktop computer, a notebook computer, a mobile phone etc, at least including a processing unit 310. The processing unit 310 can be implemented in numerous ways, such as with general-purpose hardware, such as CPU (Central Processing Unit), GPU (graphics processing units) capable of parallel computations, etc that is programmed using microcode or software instructions to perform the functions recited hereinafter. The system architecture further includes a queue 330 for storing entities, such as data, processing statuses, messages etc, which has or have been received from the access interface 150. The queue 330 stores a collection of entities being kept in order. Each entity is associated with a command issued to the processing unit 110 via the access interface 150, such as a read command, a write command etc. For example, one entity may contain the read data corresponding to a read command. One entity may contain a processing status or an error message corresponding to a write command. The operations on the collection are the addition of entities to the rear terminal position, known as enqueue, and the removal of entities from the front terminal position, known as dequeue. This makes the queue 330 a FIFO (First-In-First-Out) data structure. The first entity added to the queue 330 will be the first one to be removed and processed by the processing unit 310. FIG. 4 is a flowchart illustrating a method for interacting with a storage device performed by an interface controller according to an embodiment of the invention. An interface controller 350 issues a command via an access interface 150 of the storage device (step S410). For example, the interface controller 350 may issue a data read command with a read address via the access interface 150 to request reading data from the storage unit 180. The interface controller 350 may issue a data write command with a write address and relevant data via the access interface 150 to request that data be programmed into a designated location of the storage unit 180. The interface controller 350 receives an entity in response to the issued command, such as the read data, a processing status, an error message etc, from the storage device via the access interface 150 (step S420), and adds the received entity to the queue 330 (step S430). After completing the insertion for the received entity, the interface controller 350 sets a register 370 to indicate that an entity has been added to the queue 330 (step S440). The setting to the register 370 may be referred to as an issuance of an interrupt signal.

An interrupt handler executed by the processing unit 310 periodically inspects whether the register 370 has been set. When the register 370 has been set, an executed task is interrupted, and then, an ISR thread is loaded and executed by one core of the processing unit 310. The following describes that the ISR thread removes multiple entities from a queue, which are associated with commands issued to a storage device, and processes the removed entities until at least one condition is satisfied.

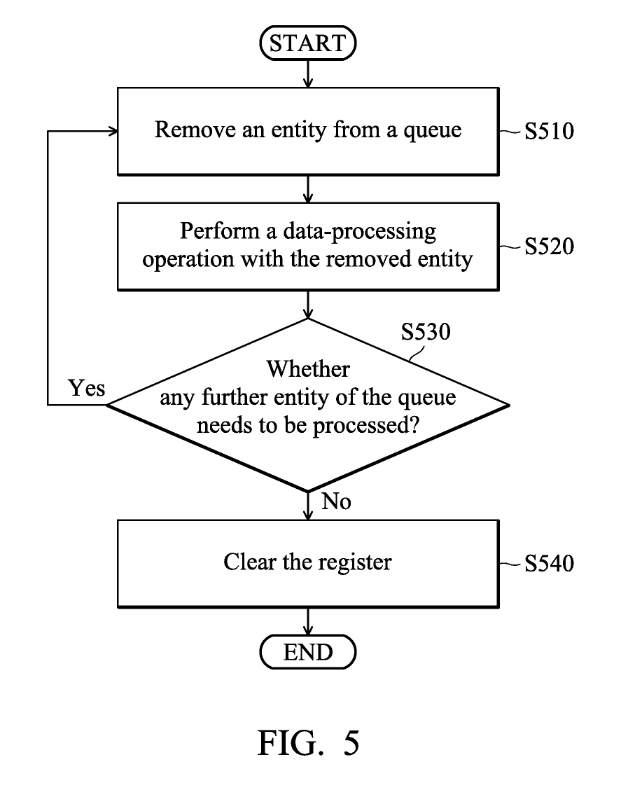

In an embodiment, the ISR thread may process entities associated with issued commands until the queue 330 is empty to eliminate the aforementioned context switch. FIG. 5 is a flowchart illustrating a method for dealing with entities kept in the queue 330 performed by a single ISR thread according to an embodiment of the invention. A loop is performed repeatedly until no entity of the queue 330 needs to be processed. In each run, the ISR thread removes an entity from the queue 330 (step S510), performs a data-processing operation with the removed entity (step S520) and determines whether any further entity of the queue 330 needs to be processed (step S530). If so, the process proceeds to remove the next entity from the queue 330 (step S510). Otherwise, the ISR thread clears the register 370 (step S540). When the ISR thread ends, the interrupted task is resumed to continue the unfinished instructions.

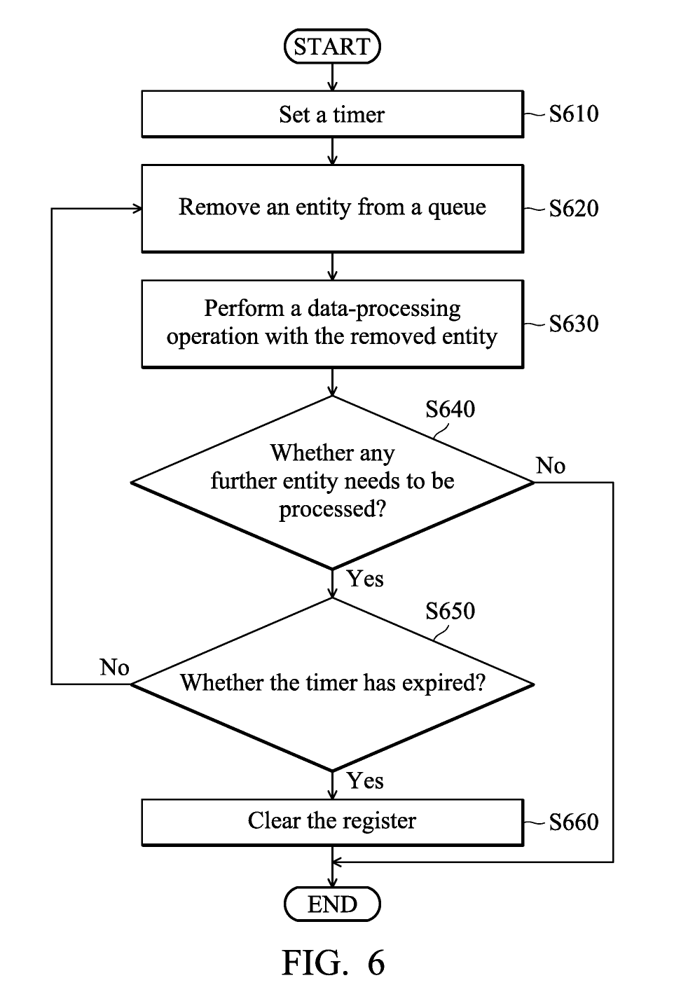

In another embodiment, the ISR thread may process entities associated with issued commands until the queue 330 is empty or process entities associated with issued commands within a predetermined time period to eliminate the aforementioned context switch. FIG. 6 is a flowchart illustrating a method for dealing with entities kept in the queue 330 performed by an ISR thread according to an embodiment of the invention. The process begins by setting a timer (step S610). The timer may be a countdown timer, a stopwatch timer, etc. The timer expires when the predetermined time period has elapsed. A loop is performed repeatedly until no entity of the queue 330 needs to be processed or the timer has expired. In each run, the ISR thread removes an entity from the queue 330 (step S620), performs a data-processing operation with the removed entity (step S630), determines whether any further entity needs to be processed (step S640) and determines whether the timer has expired (step S650). When any further entity needs to be processed (the “yes” path of step S640) and the timer has not expired (the “no” path of step S650), the process proceeds to remove the next entity from the queue 330 (step S620). Otherwise, the ISR thread clears the register 370 (step S660). When the ISR thread ends, the interrupted task is resumed to continue the unfinished instructions.

In an example, the interface controller 350 may read multimedia data, such as a time interval of audio, video data etc, by issuing multiple data read commands with continuous LBAs, and then, store replied data in the queue 330. Using the embodiments illustrated in FIGS. 5 and 6, the ISR thread may remove the read data from the queue 330, and store the read data in a buffer for further playback. In another example, the interface controller 350 may obtain image data captured by a camera module and program the image data by issuing multiple data write commands with continuous LBAs. After that, the interface controller 350 may store the replied statuses for the issued data write commands in the buffer 330. Using the embodiments illustrated in FIGS. 5 and 6, the ISR thread may remove the statuses from the queue 330, and know whether the data write commands are successful.

Although the embodiment has been described as having specific elements in FIGS. 1 and 3, it should be noted that additional elements may be included to achieve better performance without departing from the spirit of the invention. While the process flow described in FIGS. 4 to 6 each includes a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for processing return entities associated with multiple requests in a single ISR (Interrupt Service Routine) thread, performed by one core of a processing unit of a host device, comprising:
removing a plurality of entities from a queue, which are associated with a plurality of commands issued to a storage device, and processing the removed entities until a condition is satisfied.

2. The method of claim 1, wherein the commands request that the storage device perform operations with a storage unit of the storage device.

3. The method of claim 2, wherein the commands comprise a plurality of data read commands or a plurality of data write commands.

4. The method of claim 1, wherein the host device communicates with the storage device using a USB (Universal Serial Bus), an ATA (Advanced Technology Attachment), a SATA (Serial ATA) or a PCI-E (Peripheral Component Interconnect Express) protocol.

5. The method of claim 1, wherein the condition is satisfied when no entity of the queue needs to be processed.

6. The method of claim 1, further comprising:
setting a timer before removing the entities from the queue,
wherein the condition is satisfied when the timer has expired.

7. The method of claim 1, wherein the ISR thread is executed when a register is set by an interface controller, the method further comprising:
clearing the register after the condition is satisfied.

8. The method of claim 7, wherein, after storing an entity, which is received from the storage device, in the queue, the interface controller sets the register to indicate that an entity has been added to the queue.

9. An apparatus for processing return entities associated with multiple requests in a single ISR (Interrupt Service Routine) thread, comprising:
a queue; and
a processing unit comprising a plurality of cores, coupled to the queue,
wherein one core of the processing unit loads and executes the ISR thread to remove a plurality of entities from the queue, which are associated with a plurality of commands issued to a storage device, and processes the removed entities until a condition is satisfied.

10. The apparatus of claim 9, wherein the commands request that the storage device performs operations with a storage unit of the storage device.

11. The apparatus of claim 10, wherein the commands comprise a plurality of data read commands or a plurality of data write commands.

12. The apparatus of claim 9, wherein the apparatus communicates with the storage device using a USB (Universal Serial Bus), an ATA (Advanced Technology Attachment), a SATA (Serial ATA) or a PCI-E (Peripheral Component Interconnect Express) protocol.

13. The apparatus of claim 9, wherein the condition is satisfied when no entity of the queue needs to be processed.

14. The apparatus of claim 9, wherein the ISR thread is executed to set a timer before removing the entities from the queue and the condition is satisfied when the timer has expired.

15. The apparatus of claim 9, wherein the ISR thread is executed when a register is set by an interface controller and the ISR thread is executed to clear the register after the condition is satisfied.

16. The apparatus of claim 15, wherein, after storing an entity, which is received from the storage device, in the queue, the interface controller sets the register to indicate that an entity has been added to the queue.
